(19) United States
(12) Patent Application Publication
(10) Pub. No.: US 2024/0394940 A1
(43) Pub. Date: Nov. 28, 2024

(54) CONTENT EVALUATION DEVICE, COMPUTER-READABLE MEDIUM STORING CONTENT EVALUATION PROGRAM, CONTENT EVALUATION METHOD, AND CONTENT EVALUATION SYSTEM

(71) Applicant: Wacom Co., Ltd., Saitama (JP)

(72) Inventors: Nobutaka IDE, Saitama (JP); Hiroshi TAMANO, Saitama (JP); Bunta TAUCHI, Saitama (JP); Jin-Fu KO, Saitama (JP)

(21) Appl. No.: 18/790,735

(22) Filed: Jul. 31, 2024

Related U.S. Application Data
(63) Continuation of application No. PCT/JP2023/000420, filed on Jan. 11, 2023.

(30) Foreign Application Priority Data
Jan. 31, 2022 (JP) 2022-013011

(51) Int. Cl. G06T 11/20; G06V 10/44

(52) U.S. Cl. CPC G06T 11/203; G06V 10/44

(57) ABSTRACT

Provided is a content evaluation device including a processor and a memory storing a program that, when executed by the processor, causes the content evaluation device to: calculate a state feature relating to a drawing state in a creation period from a start timing to an end timing of creation of content, and generate a picture-print that is a set or locus of points on a feature space that represents the state feature.

### BACKGROUND

### Technical Field

The present disclosure relates to a content evaluation device, a computer-readable medium storing a content evaluation program, a content evaluation method, and a content evaluation system.

### Description of the Related Art

In the related art, a technique for allowing multiple users to share digital content (hereinafter, simply referred to also as “content”) that is an intangible object by using a computer system has been known (for example, refer to Japanese Patent No. 6734502).

Recently, along with the progress of artificial intelligence techniques, various machine learning models (as one example, generative adversarial networks; GANs) for generating content have been proposed. For example, it is anticipated that it becomes difficult to determine the authenticity of content merely by simply comparing the contents of drawing of a finished product, if it becomes possible to generate an imitation of content automatically and elaborately by using this kind of machine learning model.

### BRIEF SUMMARY

Embodiments of the present disclosure provide a content evaluation device, a computer-readable medium storing a content evaluation program, a content evaluation method, and a content evaluation system that can evaluate content elaborately compared with the case of executing evaluation by merely using the contents of drawing of a finished product.

A content evaluation device in a first aspect of the present disclosure includes a processor and a memory storing a program that, when executed by the processor, causes the content evaluation device to: calculate a state feature relating to a drawing state in a creation period from a start timing to an end timing of creation of content. and generate a picture-print that is a set or locus of points on a feature space that represent the state feature.

A content evaluation device in a second aspect of the present disclosure includes a processor and a memory storing a program that, when executed by the processor, causes the content evaluation device to: calculate a time series of a state feature relating to a drawing state of content created through a series of operations, obtain an amount of change in the state feature between before and after one operation by using the time series of the state feature, and calculate an operation feature relating to the one operation from the amount of change.

A computer-readable medium in a third aspect of the present disclosure stores a content evaluation program that, when executed by one or more processors, causes one or more computers to calculate a time series of a state feature relating to a drawing state of content created through a series of operations, obtain an amount of change in the state feature between before and after one operation by using the time series of the state feature, and calculate an operation feature relating to the one operation from the amount of change.

A content evaluation method in a fourth aspect of the present disclosure includes calculating, by one or more computers, a time series of a state feature relating to a drawing state of content created through a series of operations, obtaining, by one or more the computers, an amount of change in the state feature between before and after one operation by using the time series of the state feature, and calculating, by the one or more computers, an operation feature relating to the one operation from the amount of change.

A content evaluation system in a fifth aspect of the present disclosure includes a user device that, in operation, generates content data indicating content created through a series of operations and a server device that, in operation, communicates with the user device. The server device includes a at least one processor and at least one memory storing at least one program that, when executed by the processor, cause the server device to: calculate a time series of a state feature relating to a drawing state of the content, obtain an amount of change in the state feature between before and after one operation by using the time series of the state feature, and calculate an operation feature relating to the one operation from the amount of change.

According to the present disclosure, the content can be evaluated elaborately compared with the case of executing evaluation by merely using the contents of drawing of a finished product.

### BRIEF DESCRIPTION OF THE VIEWS OF THE DRAWINGS

FIG. 1 is an overall configuration diagram of a content evaluation system in one embodiment of the present disclosure;

FIG. 2 is a block diagram illustrating one example of a configuration of a server device in FIG. 1;

FIG. 3 is a detailed functional block diagram of a feature calculating section illustrated in FIG. 2;

FIG. 4 is a flowchart illustrating one example of an operation of calculating feature information by the server device;

FIG. 5 is a diagram illustrating one example of content created by use of a user device in FIG. 1;

FIG. 6 is a diagram illustrating a transition of the drawing state of an artwork in FIG. 5;

FIG. 7 is a diagram illustrating one example of a data structure of content data in FIG. 1 and FIG. 2;

FIG. 8 is a diagram illustrating one example of a data structure of graph data in FIG. 3;

FIG. 9 is a diagram illustrating one example of a data structure of first picture-print data;

FIG. 10 is a diagram illustrating one example of a method of calculating a state feature;

FIG. 11 is a diagram illustrating one example of a data structure of second picture-print data;

FIG. 12 is a diagram illustrating one example of a method of calculating an operation feature;

FIG. 13 is a diagram illustrating a first example of an identification method of a creation step; and

FIG. 14 is a diagram illustrating a second example of the identification method of the creation step.

### DETAILED DESCRIPTION

An embodiment of the present disclosure will be described below with reference to the accompanying drawings. To facilitate understanding of the description, the same constituent element is given the same numeral as much as possible in the respective drawings, and overlapping description is omitted.

### Configuration of Content Evaluation System 10

### Overall Configuration

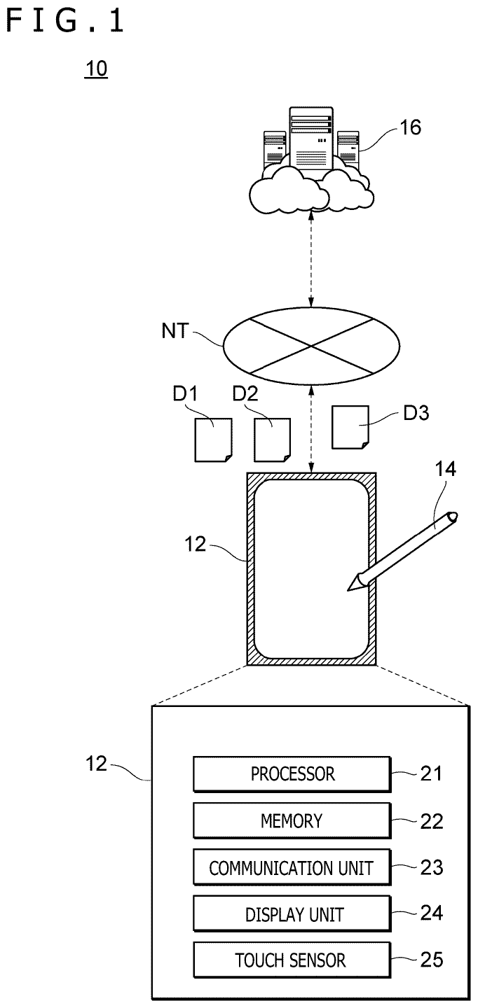

FIG. 1 is an overall configuration diagram of a content evaluation system 10 in one embodiment of the present disclosure. The content evaluation system 10 is made in order to provide a “content evaluation service” for evaluating computerized content (what is generally called digital content). Specifically, the content evaluation system 10 includes one or multiple user devices 12, one or multiple electronic pens 14, and a server device 16 (equivalent to a “content evaluation device”). Each user device 12 and the server device 16 are connected to be communicable with each other through a network NT.

The user device 12 is a computer owned by a user (for example, a creator of content) who uses the content evaluation service, and is configured by a tablet, a smartphone, a personal computer, or the like, for example. The user device 12 is configured to be capable of generating content data D1 and related data D2 to be both described later and supplying various kinds of data generated by the user device 12 to the server device 16 through the network NT. Specifically, the user device 12 includes a processor 21, a memory 22, a communication unit 23, a display unit 24, and a touch sensor 25.

The processor 21 is configured by a computation processing device including a central processing unit (CPU), a graphics processing unit (GPU), and a micro-processing unit (MPU). The processor 21 executes generation processing to generate ink data (hereinafter, referred to also as digital ink) that describes content, rendering processing to cause display of content indicated by digital ink, and so forth, by reading out a program and data stored in the memory 22.

The memory 22 stores the programs and data necessary for the processor 21 to control the constituent elements. The memory 22 is configured by a non-transitory computer-readable storage medium. Here, the computer-readable storage medium is configured by [1] a storage device such as a hard disk (hard disk drive (HDD)) or a solid state drive (SSD) incorporated in a computer system, [2] a portable medium such as a magneto-optical disc, a read only memory (ROM), a compact disk (CD)-ROM, or a flash memory, or the like.

The communication unit 23 has a communication function to execute wired communication or wireless communication with an external device. This allows the user device 12 to, for example, exchange various kinds of data such as the content data D1, the related data D2, and presentation data D3 with the server device 16.

The display unit 24 can visibly display content including an image or video and is configured by a liquid crystal panel, an organic electro-luminescence (EL) panel, or an electronic paper, for example. By allowing the display unit 24 to have flexibility, the user can execute various kinds of writing operations with a touch surface of the user device 12 remaining in a curved or bent state.

The touch sensor 25 is a sensor of a capacitance system obtained by disposing multiple sensor electrodes in a planner manner. For example, the touch sensor 25 includes multiple X line electrodes for detecting a position in an X-axis of a sensor coordinate system and multiple Y line electrodes for detecting a position in a Y-axis. The touch sensor 25 may be a sensor of the self-capacitance system in which block-shaped electrodes are disposed in a two-dimensional lattice manner, instead of the above-described sensor of the mutual capacitance system.

The electronic pen 14 is a pen-type pointing device and is configured to be capable of unidirectionally or bidirectionally communicating with the user device 12. For example, the electronic pen 14 is a stylus of the active capacitance (AES) system or the electromagnetic resonance (EMR) system. The user can write pictures, characters, and so forth to the user device 12 by gripping the electronic pen 14 and moving the electronic pen 14 while pressing the pen tip against a touch surface of the user device 12.

The server device 16 is a computer that executes comprehensive control relating to evaluation of content, and may be of either a cloud type or an on-premise type. Here, the server device 16 is illustrated as a single computer. However, the server device 16 may be a computer group that constructs a distributed system, instead of the single computer.

### Block Diagram of Server Device 16

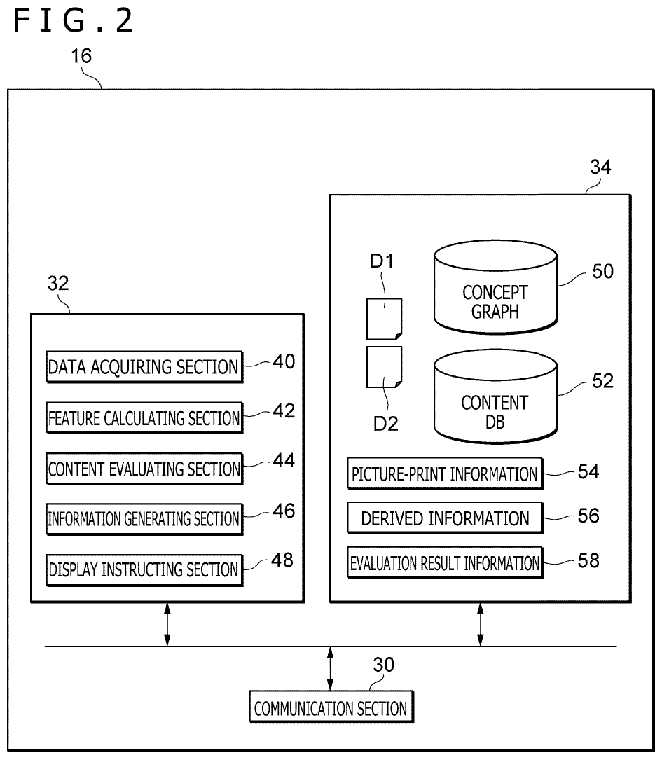

FIG. 2 is a block diagram illustrating one example of a configuration of the server device 16 in FIG. 1. Specifically, the server device 16 includes a communication section 30, a control section 32, and a storing section 34.

The communication section 30 is an interface that transmits and receives an electrical signal to and from an external device. This allows the server device 16 to acquire at least one of the content data D1 and the related data D2 from the user device 12 and provide the presentation data D3 generated by the server device 16 to the user device 12.

The control section 32 is configured by a processor including a CPU and a GPU. The control section 32 functions as a data acquiring section 40, a feature calculating section 42, a content evaluating section 44 (equivalent to an “authenticity determining section” or a “step identifying section”), an information generating section 46 (equivalent to a “picture-print generating section”), and a display instructing section 48 by reading out a program and data stored in the storing section 34 and executing the program.

The data acquiring section 40 acquires various kinds of data (for example, the content data D1, the related data D2, and so forth) relating to content that is an evaluation target. The data acquiring section 40 may acquire the various kinds of data from an external device through communication or acquire the various kinds of data through reading out them from the storing section 34.

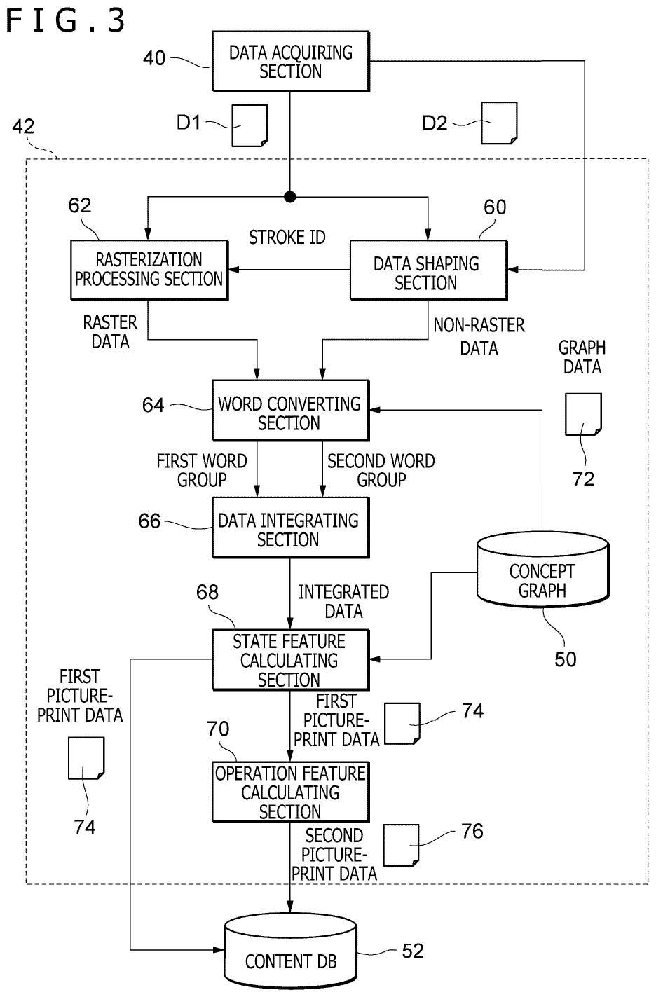

The feature calculating section 42 calculates a feature relating to content from at least one of the content data D1 and the related data D2 acquired by the data acquiring section 40. In this feature, [1] a feature relating to the drawing state of the content (hereinafter, referred to as a “state feature”) or [2] a feature relating to individual operations executed for creating the content (hereinafter, referred to as an “operation feature”) is included. A specific configuration of the feature calculating section 42 will be described in detail with FIG. 3.

The content evaluating section 44 executes evaluation processing to evaluate content by using the time series of the state feature or the operation feature calculated by the feature calculating section 42. For example, the content evaluating section 44 evaluates [1] the style of content, [2] creator's habit, [3] the psychological state of the creator, or [4] the state of the external environment. Here, the “style” means individuality or thought of the creator that appears in the content. As one example of the “habit,” use of color, the tendency of drawing of a stroke, the tendency of usage of equipment, the degree of operation error, and so forth are cited. As one example of the “psychological state,” besides emotions including delight, anger, sorrow, and pleasure, various states such as drowsiness, relaxation, and nervousness are cited. As one example of the “external environment,” the ambient brightness, cold and warm temperatures, the weather, the season, and so forth are cited.

Further, the content evaluating section 44 obtains the degree of similarity between the time series of a feature corresponding to content of an evaluation target (that is, a first time-series feature) and the time series of a feature corresponding to authentic content (that is, a second time-series feature), and determines the authenticity of the content of the evaluation target on the basis of this degree of similarity. For this degree of similarity, for example, various indexes including a correlation coefficient, a norm, and so forth are used.

Moreover, the content evaluating section 44 can estimate the kind of creation step corresponding to the drawing state of content by using the time series of the state feature or the operation feature calculated by the feature calculating section 42. As one example of the kind of creation step, a composition step, a line drawing step, a coloring step, a finishing step, and so forth are cited. In addition, the coloring step may be subdivided into an underpainting step, a main painting step, and so forth, for example.

The information generating section 46 generates picture-print information 54 or derived information 56 to be both described later, by using the time series of various features (more specifically, the state feature or the operation feature) calculated by the feature calculating section 42. Alternatively, the information generating section 46 generates evaluation result information 58 indicating a result of evaluation performed by the content evaluating section 44.

The display instructing section 48 makes an instruction to display the information generated by the information generating section 46. In this “display,” besides the case of displaying the information on an output device (not illustrated) disposed in the server device 16, the case of transmitting the presentation data D3 including the picture-print information 54, the derived information 56, or the evaluation result information 58 to an external device such as the user device 12 (FIG. 1) is also included.

The storing section 34 stores the programs and data necessary for the control section 32 to control the constituent elements. The storing section 34 is configured by a non-transitory computer-readable storage medium. Here, the computer-readable storage medium is configured by [1] a storage device such as an HDD or an SSD incorporated in a computer system, [2] a portable medium such as a magneto-optical disc, a ROM, a CD-ROM, or a flash memory, or the like.

In the example of FIG. 2, in the storing section 34, a database relating to the concept of a word (hereinafter, referred to as a “concept graph 50”) and a database relating to content (hereinafter, referred to as a “content DB 52”) are constructed, and the picture-print information 54, the derived information 56, and the evaluation result information 58 are stored.

The concept graph 50 is a graph indicating the relation between words (that is, an ontology graph) and is configured by nodes and links (or edges). Coordinate values on an N-dimensional (for example, N≥3) feature space are associated with individual words configuring the nodes. That is, the individual words are quantified as “distributed representation” of natural language processing.

In the concept graph 50, nouns, adjectives, adverbs, verbs, and compounds made by combining them are included. Further, not only words that directly represent the form of content (for example, the kind, colors, shape, pattern, or the like of an object) but also words relating to mental representation of an emotion, state, or the like may be registered in the concept graph 50. Moreover, not only words routinely used but also words that are not routinely used (for example, a fictional object or the kind of creation step) may be included in the concept graph 50. In addition, the concept graph 50 may be made for each of the kinds of languages such as Japanese, English, and Chinese. By using different concept graphs 50 as appropriate, cultural differences from country to country or from region to region can be reflected more elaborately.

In the content DB 52, [1] the content data D1, [2] the related data D2, and [3] information generated by use of the content data D1 or the related data D2 (hereinafter, referred to as “generated information”) are registered in association with each other. In this “generated information,” the picture-print information 54, the derived information 56, and the evaluation result information 58 are included.

The content data D1 is an aggregate of content elements configuring content and is configured to be capable of expressing the creation process of the content. For example, the content data D1 is formed of ink data (hereinafter, digital ink) for expressing content made by handwriting. As an “ink description language” for describing the digital ink, for example, Wacom Ink Layer Language (WILL), Ink Markup Language (InkML), and Ink Serialized Format (ISF) are cited. The content may be an artwork (or digital art) including a picture, a calligraphic work, illustrations, characters, and so forth, for example.

The related data D2 includes various kinds of information relating to creation of content. As the related data D2, for example, the following kinds of data are cited: [1] creator information including identification information, attributes, and so forth of the creator of content, [2] “setting conditions of the device driver side” including the resolution, size, and kind of the display unit 24, the detection performance and kind of the touch sensor 25, the shape of a writing pressure curve, and so forth, [3] “setting conditions of the drawing application side” including the kind of content, color information of a color palette and a brush, settings of visual effects, and so forth, [4] “operation history of the creator” sequentially stored through execution of a drawing application, [5] “vital data” indicating the biological state of the creator, and the like.

The picture-print information 54 includes a picture-print defined on the above-described feature space or a processed picture-print. Here, the “picture-print” means a set or locus of points on the feature space for representing the state feature. As one example of the “processed picture-print,” a picture-print resulting from reduction in the number of dimensions (that is, a sectional view), a picture-print resulting from decimation of the number of points, and so forth are cited. The picture-print information 54 is stored in association with the above-described creator information, specifically, identification information of content or a creator.

The derived information 56 is information derived from the picture-print information 54 and, for example, includes visible information for giving awareness to the creator of content (hereinafter, referred to as “awareness information”). As one example of the awareness information, [1] a word group as the state feature and [2] another representation obtained by making a word included in this word group abstract or euphemistic (for example, a symbol indicating the strength of characteristics, another word with high similarity, or the like) are cited. The derived information 56 is stored in association with the creator information (specifically, identification information of content or a creator) similarly to the picture-print information 54.

The evaluation result information 58 indicates the result of content evaluation performed by the content evaluating section 44. As one example of the evaluation result, [1] the result of a single-entity evaluation including a classification category, a score, and so forth and [2] the result of a comparative evaluation including the degree of similarity, authenticity determination, and so forth are cited.

### Functional Block Diagram of Feature Calculating Section 42

FIG. 3 is a detailed functional block diagram of the feature calculating section 42 illustrated in FIG. 2. The feature calculating section 42 functions as a data shaping section 60, a rasterization processing section 62, a word converting section 64, a data integrating section 66, a state feature calculating section 68 (equivalent to a “first calculating section”), and an operation feature calculating section 70 (equivalent to a “second calculating section”).

The data shaping section 60 executes shaping processing for the content data D1 and the related data D2 acquired by the data acquiring section 40 and outputs shaped data (hereinafter, referred to as “non-raster data”). Specifically, the data shaping section 60 executes [1] association processing to associate the content data D1 and the related data D2 with each other, [2] giving processing to give the sequential order to a series of operations in the creation period of content, and [3] removal processing to remove unnecessary data. Here, as one example of the “unnecessary data,” [1] operation data relating to a user operation canceled in the creation period, [2] operation data relating to a user operation that does not contribute to the completion of the content, [3] various kinds of data in which consistency is not recognized as the result of execution of the above-described association processing, and so forth are cited.

The rasterization processing section 62 executes “rasterization processing” to convert vector data included in the content data D1 acquired by the data acquiring section 40 to raster data. The vector data means stroke data indicating the form of a stroke (for example, the shape, thickness, color, and so forth). The raster data means image data composed of multiple pixel values.

The word converting section 64 executes data conversion processing to convert input data to one or two or more words (hereinafter, referred to as a word group). The word converting section 64 includes a first converter for outputting a first word group and a second converter for outputting a second word group.

The first converter is configured by a learner that treats the raster data from the rasterization processing section 62 as input and treats tensor data indicating the detection result of an image (existence probability relating to the kind and the position of an object) as output. This learner may be constructed by a convolutional neural network (for example, “Mask R-CNN” or the like) for which machine learning has been executed, for example. The word converting section 64 refers to graph data 72 that describes the concept graph 50, and decides, as the “first word group,” a word group registered in the concept graph 50 in word groups indicating the kind of object detected by the first converter.

The second converter is configured by a learner that treats the non-raster data from the data shaping section 60 as input and treats the score of each word as output. This learner may be constructed by a neural network (for example, “LightGBM,” “XGBoost,” or the like) for which machine learning has been executed, for example. The word converting section 64 refers to the graph data 72 that describes the concept graph 50, and decides, as the “second word group,” a word group registered in the concept graph 50 in word groups converted by the second converter.

The data integrating section 66 integrates data (more specifically, the first word group and the second word group) regarding each operation sequentially obtained by the word converting section 64. This operation is a “stroke operation” for drawing one stroke but may be various user operations that can affect creation of content in conjunction with or separately from the stroke operation. Further, this integration may be executed in units of each one operation or may be executed in units of consecutive two or more operations.

The state feature calculating section 68 calculates, in a time-series manner, the feature relating to the drawing state of content created through a series of operations (hereinafter, referred to as the “state feature”), on the basis of both the raster data and the stroke data of the content. The time series of this state feature is equivalent to the “picture-print” that is a pattern specific to the content. For example, this state feature may be [1] the kind and the number of words configuring a word group or [2] a coordinate value on the feature space defined by the concept graph 50. Alternatively, the state feature calculating section 68 may identify the kind of language from the content data D1 or the related data D2 and calculate the time series of the state feature by using the concept graph 50 corresponding to the kind of language.

The operation feature calculating section 70 obtains the amount of change in the state feature between before and after a single or consecutive operations by using the time series of the state feature calculated by the state feature calculating section 68, and calculates the operation feature relating to the operation from the amount of change in a time-series manner. The time series of this operation feature is equivalent to the “picture-print” that is a pattern specific to the content. For example, this operation feature is the magnitude or the direction of a vector that has a first drawing state immediately before execution of one operation as the initial point and has a second drawing state immediately after the execution of the one operation as the terminal point.

### Operation of Content Evaluation System 10

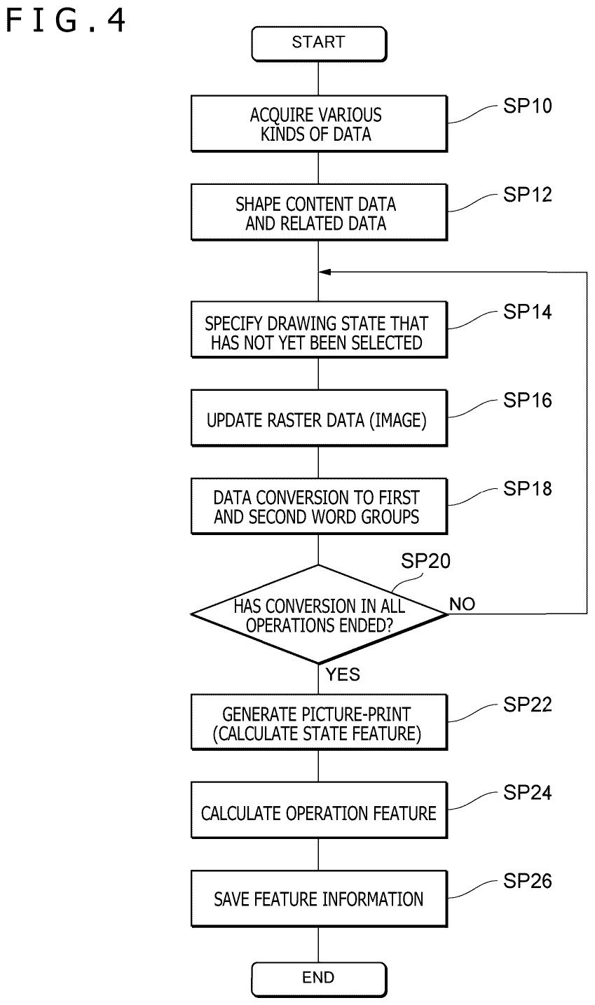

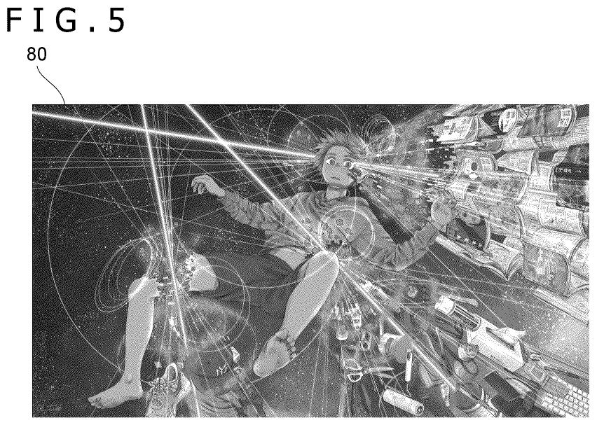

The content evaluation system 10 in this embodiment is configured as above. Subsequently, an operation of the server device 16 configuring part of the content evaluation system 10, specifically, an operation of calculating feature information, will be described with reference to the functional block diagram of FIG. 3, a flowchart of FIG. 4, and FIG. 5 to FIG. 12.

At SP10 in FIG. 4, the data acquiring section 40 acquires various kinds of data relating to content of an evaluation target, for example, at least one of the content data D1 and the related data D2.

FIG. 5 is a diagram illustrating one example of content created by use of the user device 12 in FIG. 1. The content of this diagram is an artwork 80 created by handwriting. The creator of the content completes the desired artwork 80 while using the user device 12 and the electronic pen 14. The artwork 80 is created through a series of operations by the creator or multiple kinds of creation steps.

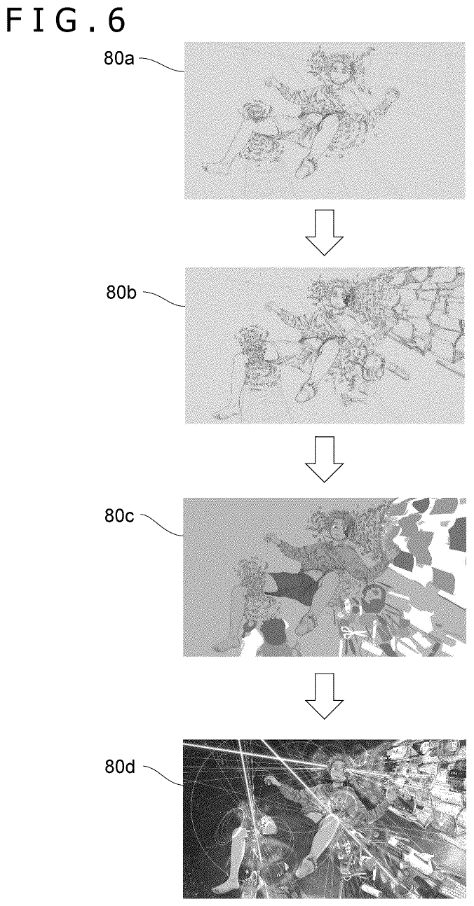

FIG. 6 is a diagram illustrating a transition of the drawing state of the artwork 80 in FIG. 5. A first in-progress work 80a indicates the drawing state in a “composition step” in which the overall composition is settled. A second in-progress work 80b indicates the drawing state in a “line drawing step” in which a line drawing is made. A third in-progress work 80c indicates the drawing state in a “coloring step” in which color painting is executed. A fourth in-progress work 80d indicates the drawing state in a “finishing step” for finishing.

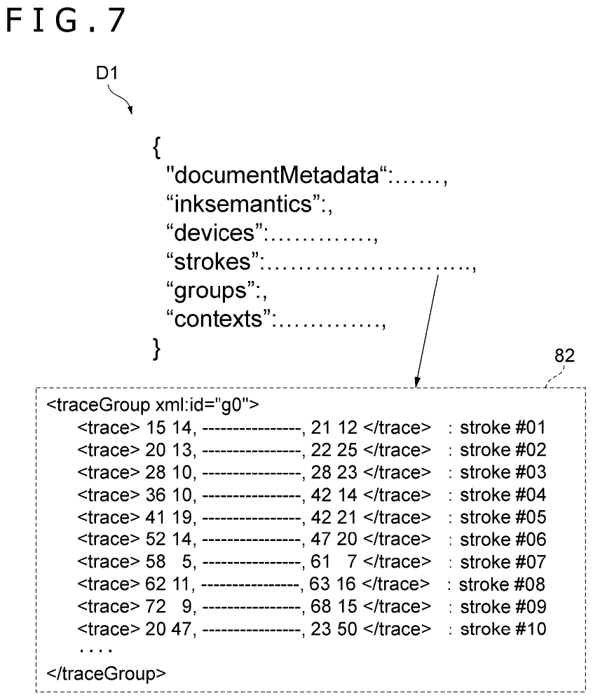

FIG. 7 is a diagram illustrating one example of a data structure that the content data D1 in FIG. 1 and FIG. 2 has. In the example of FIG. 7, the case in which the content data D1 is digital ink is illustrated. The digital ink has a data structure obtained by sequentially arranging [1] document metadata (documentMetadata), [2] semantic data (inksemantics), [3] device data (devices), [4] stroke data (strokes), [5] classification data (groups), and [6] context data (contexts).

Stroke data 82 is data for describing individual strokes configuring content made by handwriting and indicates the shape of the strokes configuring the content and the order of writing of the strokes. As is understood from FIG. 7, one stroke is described by multiple pieces of point data sequentially arranged in <trace> tags. Each point data is composed of at least an indicated position (X-coordinate, Y-coordinate) and is marked off by a delimiter such as a comma. For convenience of illustration, only the pieces of point data indicating the start point and the end point of the stroke are represented, and the pieces of point data indicating multiple passing points are omitted. In this point data, besides the above-described indicated position, the order of generation or editing of the stroke, the writing pressure and the posture of the electronic pen 14, and so forth may be included.

At SP12 in FIG. 4, the data shaping section 60 executes shaping processing for the content data D1 and the related data D2 acquired at SP10. By this shaping, pieces of data that are not of the raster format (hereinafter, referred to also as the “non-raster data”) are associated with each other for every stroke operation.

At SP14, the feature calculating section 42 specifies one drawing state that has not yet been selected in the creation period of the content. The feature calculating section 42 specifies the drawing state resulting from execution of the first stroke operation, in the first round of the processing.

At SP16, the rasterization processing section 62 executes rasterization processing to reproduce the drawing state specified at SP14. Specifically, the rasterization processing section 62 executes drawing processing to add one stroke to the most recent image. This updates the raster data (that is, the image) that is the conversion target.

At SP18, the word converting section 64 converts the respective pieces of data made at SP14 and SP16 to word groups composed of one or two or more words. Specifically, the word converting section 64 converts the raster data from the rasterization processing section 62 to the first word group and converts the non-raster data from the data shaping section 60 to the second word group. The word converting section 64 refers to the graph data 72 that describes the concept graph 50, when executing [1] the conversion of the raster data and [2] the conversion of the non-raster data.

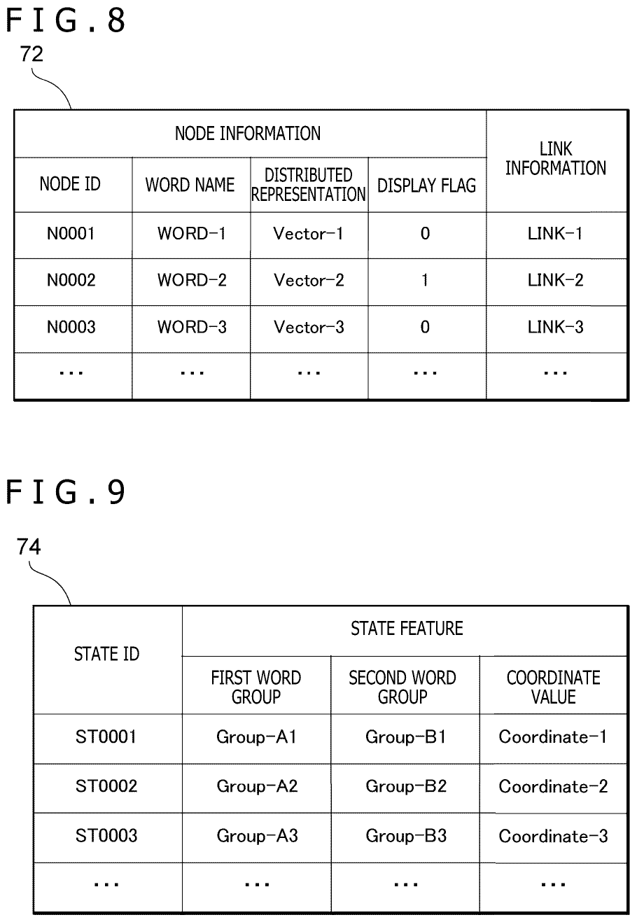

FIG. 8 is a diagram illustrating one example of a data structure that the graph data 72 in FIG. 3 has. The graph data 72 is data of a table format indicating the correspondence relation between “node information” relating to nodes configuring the graph and “link information” relating to links configuring the graph. In the node information, for example, a node identification (ID), a word name, distributed representation (a coordinate value on the feature space), and a display flag are included. In the link information, whether or not the link between nodes exists and a label given to each link are included.

At SP20 in FIG. 4, the feature calculating section 42 checks whether or not the data conversion in all stroke operations has ended. Because the conversion has not yet ended in the first round of the processing (SP20: NO), the feature calculating section 42 returns to SP14.

At SP14, the feature calculating section 42 specifies the drawing state resulting from execution of the second stroke operation, in the second round of the processing. From then on, the feature calculating section 42 sequentially repeats the operations of SP14 to SP20 until the data conversion in all drawing states ends. While this operation is repeated, the data integrating section 66 aggregates and integrates data for every stroke operation. Thereafter, when the data conversion in all stroke operations has ended (SP20: YES), the processing proceeds to SP22.

At SP22, the state feature calculating section 68 calculates the time series of the state feature by using the integrated data integrated through the execution of SP14 to SP20. This generates first picture-print data 74 indicating a first picture-print.

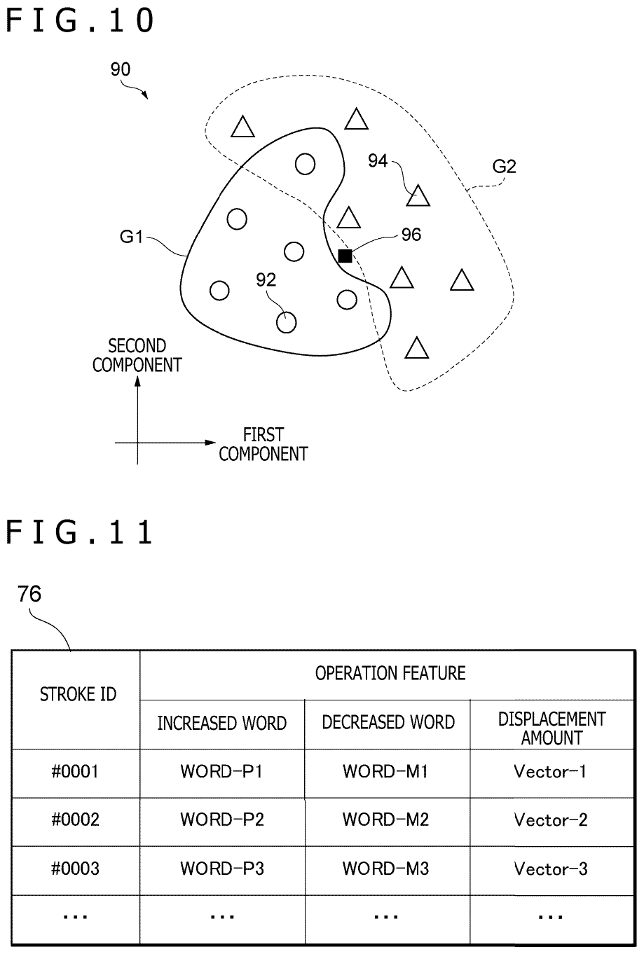

FIG. 9 is a diagram illustrating one example of a data structure that the first picture-print data 74 has. The first picture-print data 74 is data of a table format indicating the correspondence relation between a “state ID” that is identification information of the drawing state of the artwork 80 and the “state feature” relating to the drawing state. In the state feature, for example, the first word group, the second word group, and a coordinate value are included. This coordinate value is defined on an N-dimensional feature space 90. The number N of dimensions is an integer equal to or larger than three, and it is desirable that the number N be a numerical value on the order of several hundreds. FIG. 10 is a diagram illustrating one example of a method of calculating the state feature. The feature space 90 is represented in a plane coordinate system in which a first component and a second component are indicated on two axes, for convenience of illustration. A word group G1 equivalent to the first word group is composed of multiple (in the example of this diagram, six) words 92. A word group G2 equivalent to the second word group is composed of multiple (in the example of this diagram, seven) words 94.

Here, the state feature calculating section 68 obtains the union of the two word groups G1 and G2 and calculates the coordinate value of a representative point 96 of the point set as the feature in the drawing state (that is, the state feature). The state feature calculating section 68 may obtain the union by using all words that belong to the word groups G1 and G2 or obtain the union after excluding words with a low relation with the other words (specifically, independent nodes without a link). Further, for example, the state feature calculating section 68 may identify the centroid of the point set as the representative point 96 or identify the representative point 96 by using another statistical method.

At SP24 in FIG. 4, the operation feature calculating section 70 calculates the time series of the operation feature by using the time series of the state feature calculated at SP22. This generates second picture-print data 76 indicating a second picture-print.

FIG. 11 is a diagram illustrating one example of a data structure that the second picture-print data 76 has. The second picture-print data 76 is data of a table format indicating the correspondence relation between a “stroke ID” that is identification information of a stroke operation and the “operation feature” relating to each stroke operation. In the operation feature, for example, an increased word, a decreased word, and a displacement amount are included. The displacement amount is defined on the N-dimensional feature space 90 similarly to the “coordinate value” in FIG. 9.

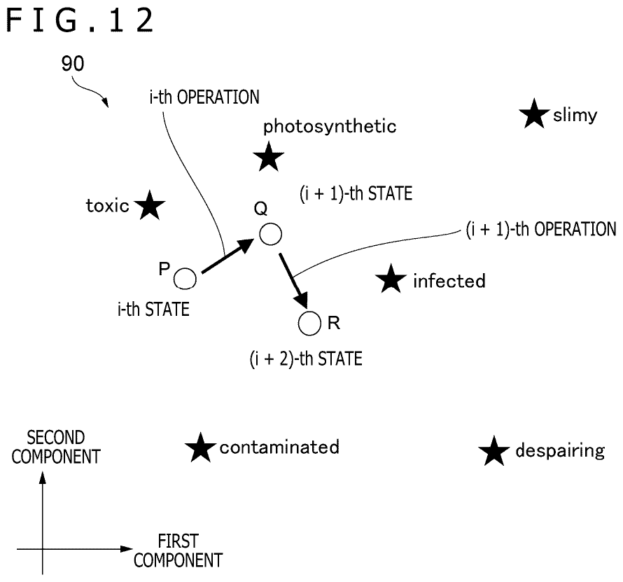

FIG. 12 is a diagram schematically illustrating one example of a method of calculating the operation feature. The feature space 90 is represented in a plane coordinate system in which a first component and a second component are indicated on two axes, as in the case of FIG. 10, for convenience of illustration. Star marks in FIG. 12 indicate the positions of words defined by the concept graph 50 (what is generally called distributed representation). Circle marks in FIG. 12 indicate the positions of the drawing states (that is, the state feature).

For example, suppose that a transition is made to the (i+1)-th drawing state by executing the i-th stroke operation from the i-th drawing state. In this case, a vector (or a displacement amount) that has a position P as the initial point and has a position Q as the terminal point is equivalent to the i-th operation feature. Similarly, a vector (or a displacement amount) that has the position Q as the initial point and has a position R as the terminal point is equivalent to the (i+1)-th operation feature.

At SP26 in FIG. 4, the feature calculating section 42 saves the feature information calculated in each of SP22 and SP24. Specifically, the feature calculating section 42 supplies the first picture-print data 74 and the second picture-print data 76 to the storing section 34 in the state in which the first picture-print data 74 and the second picture-print 76 are associated with the content or the creator. This causes the first picture-print data 74 and the second picture-print data 76 to be each registered in the content DB 52 in an available state. Through the above, the server device 16 ends the operation illustrated in the flowchart of FIG. 4.

### Use Examples of Picture-Print Data

### First Example: Identification of Creation Step

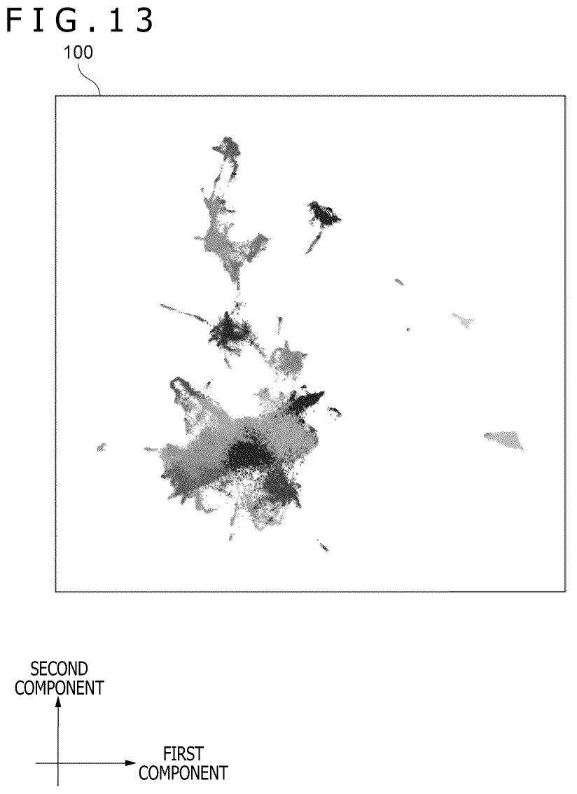

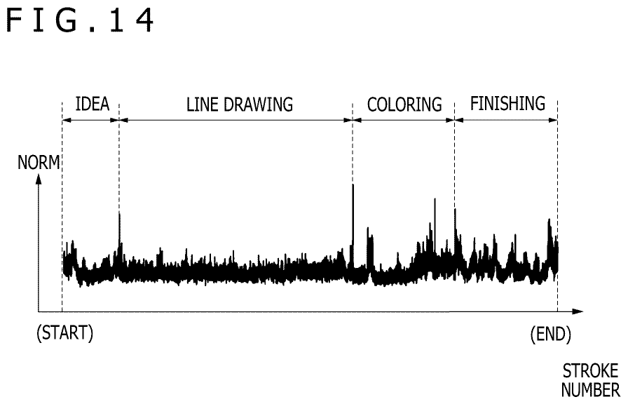

The content evaluating section 44 may identify the kind of creation step corresponding to the drawing state of the artwork 80 by using the time series of the state feature or the operation feature (that is, the picture-print data). For example, when a word indicating the creation step is defined in the concept graph 50, the content evaluating section 44 can identify the creation step according to whether or not the word included in the first word group or the second word group exists. Description will be made below regarding an identification method of the creation step in a case in which a word indicating the creation step is not defined in the concept graph 50, with reference to FIG. 13 and FIG. 14.

FIG. 13 is a diagram illustrating a first example of the identification method of the creation step. A feature space is represented in a plane coordinate system in which a first component and a second component are indicated on two axes, as in the cases of FIG. 10 and FIG. 12, for convenience of illustration. A picture-print 100 of FIG. 13 indicates a series of creation processes from the start timing to the end timing of creation of the artwork 80. More specifically, the picture-print 100 is an aggregate of the representative points 96 (FIG. 10) calculated for every stroke operation. The points configuring the picture-print 100 are drawn with different gray levels according to the kind of creation step. As is understood from FIG. 13, there is a tendency that a cluster of point sets is formed for each creation step. Thus, the content evaluating section 44 executes clustering processing for point sets of the picture-print 100 and can identify the creation step according to whether or not a segmented group belongs to the creation step. The picture-print 100 may be a locus formed of one line instead of the aggregate of points (that is, a scatter plot).

FIG. 14 is a diagram illustrating a second example of the identification method of the creation step. The abscissa axis of the graph indicates the stroke ID, and the ordinate axis of the graph indicates the operation feature. This operation feature is equivalent to the magnitude of the displacement amount of the state feature, that is, the “norm” of a vector. As is understood from this diagram, a tendency that the feature point greatly moves at the timing of a transition to the next creation step and the norm increases temporarily and sharply is found. Hence, the content evaluating section 44 executes peak detection processing for the time profile of the operation feature and can identify the transition timings of the creation step from the positional relation among detected multiple peaks.

### Second Example: Presentation of Awareness Information

The server device 16 may present various kinds of information relating to creation activities to the creator of the artwork 80. In this case, the display instructing section 48 makes an instruction to display the picture-print information 54 or the derived information 56 generated by the information generating section 46. More specifically, the display instructing section 48 transmits the presentation data D3 including the picture-print information 54 or the derived information 56 relating to the artwork 80 to the user device 12 owned by the creator of the artwork 80.

Thereupon, the processor 21 of the user device 12 generates a display signal by using the presentation data D3 received from the server device 16 and supplies the display signal to the display unit 24. This causes the picture-print information 54 or the derived information 56 to be made visible and be displayed in a display screen that the display unit 24 has.

For example, the user device 12 may display the awareness information that is one mode of the derived information 56, in conjunction with the artwork 80. By making the awareness information visible, it becomes possible to prompt the creator to make a new discovery or interpretation regarding the artwork 80, and a new inspiration is given to the creator. As a result, a “positive spiral” relating to creation activities of art is generated.

### Summarization of Embodiment

As above, the content evaluation system 10 in this embodiment includes one or multiple user devices 12 capable of generating the content data D1 indicating content (for example, the artwork 80) and the content evaluation device (here, the server device 16) configured to be capable of communicating with each user device 12.

[1] The server device 16 includes the feature calculating section 42 that calculates the state feature relating to the drawing state in the creation period from the start timing to the end timing of creation of the artwork 80, and the picture-print generating section (here, the information generating section 46) that generates the picture-print 100 that is a set or locus of points on the feature space 90 for representing the state feature calculated by the feature calculating section 42.

Further, according to a content evaluation method and a content evaluation program in this embodiment, one or multiple computers (here, the server device 16) calculate the state feature relating to the drawing state in the creation period from the start timing to the end timing of creation of the artwork 80 (SP22 in FIG. 4), and generates the picture-print 100 that is a set or locus of points on the feature space 90 for representing the calculated state feature.

As above, the set or locus of points on the feature space 90 for representing the state feature relating to the drawing state, that is, the picture-print 100, is generated. Thus, the artwork 80 can be evaluated elaborately compared with the case of executing evaluation by merely using the contents of drawing of a finished product.

Moreover, the server device 16 may further include the display instructing section 48 that makes an instruction to display the picture-print information 54 relating to the picture-print 100 or the derived information 56 derived from the picture-print information 54. In addition, when the state feature has the number of dimensions larger than three, the picture-print information 54 may be a picture-print resulting from reduction in the number of dimensions to three or less. Further, the derived information 56 may be the awareness information for giving awareness to the creator of the artwork 80. Moreover, the server device 16 may further include the content evaluating section 44 that evaluates the artwork 80 by using picture-print data (here, the first picture-print data 74 or the second picture-print data 76) indicating the picture-print 100.

[2] The server device 16 includes the first calculating section (here, the state feature calculating section 68) that calculates the time series of the state feature relating to the drawing state of content (here, the artwork 80) created through a series of operations and the second calculating section (here, the operation feature calculating section 70) that obtains the amount of change in the state feature between before and after one operation by using the time series of the state feature calculated by the state feature calculating section 68 and calculates the operation feature relating to the one operation from the amount of change.

Further, according to a content evaluation method and a content evaluation program in this embodiment, one or multiple computers (here, the server device 16) execute a first calculation (SP22 in FIG. 4) of calculating the time series of the state feature relating to the drawing state of the artwork 80 created through a series of operations and a second calculation (SP24 in FIG. 4) of obtaining the amount of change in the state feature between before and after a single or consecutive operations by using the calculated time series of the state feature and calculating the operation feature relating to the single or consecutive operations from the amount of change.

As above, the amount of change in the state feature between before and after one operation is obtained, and the operation feature relating to the one operation is calculated from the amount of change. Thus, the artwork 80 can be evaluated elaborately compared with the case of executing evaluation by merely using the contents of drawing of a finished product.

Moreover, the state feature may be a coordinate value on the feature space 90 defined by the concept graph 50 indicating the relation between words. Further, when the concept graph 50 is made for each of the kinds of languages, the state feature calculating section 68 may identify the kind of language from at least one of the content data D1 indicating the artwork 80 and the related data D2 relating to the creation of the artwork 80 and calculate the time series of the state feature by using the concept graph 50 corresponding to the kind of language. Moreover, the state feature calculating section 68 may calculate the time series of the state feature on the basis of at least both raster data and stroke data of the artwork 80.

Further, the operation feature may be the magnitude or the direction of a vector that has, as the initial point, the first drawing state immediately before execution of a stroke operation for drawing one stroke and has, as the terminal point, the second drawing state immediately after the execution of the stroke operation. Moreover, the content evaluating section 44 may identify the kind of creation step corresponding to the drawing state of the artwork 80 by using the time series of the state feature or the operation feature.

### Modification Examples

It is obvious that the present disclosure is not limited to the above-described embodiment and can freely be changed without departing from the gist of this disclosure. Alternatively, the configurations may freely be combined in a range in which no contradiction is caused technically. Alternatively, the order of execution of the steps configuring the flowchart may be changed in a range in which no contradiction is caused technically.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A content evaluation device comprising:
a processor; and
a memory storing a program that, when executed by the processor, causes the content evaluation device to:
calculate a state feature relating to a drawing state in a creation period from a start timing to an end timing of creation of content; and
generate a picture-print that is a set or locus of points on a feature space that represents the state feature.

2. The content evaluation device according to claim 1, wherein the program, when executed by the processor, causes the content evaluation device to:
generate an instruction to display picture-print information relating to the picture-print or derived information derived from the picture-print information.

3. The content evaluation device according to claim 2, wherein
the state feature has a number of dimensions larger than three, and
the picture-print information is the picture-print resulting from reduction in the number of dimensions to three or less.

4. The content evaluation device according to claim 2, wherein
the derived information is awareness information that gives awareness to a creator of the content.

5. The content evaluation device according to claim 1, wherein the program, when executed by the processor, causes the content evaluation device to:
evaluate the content by using picture-print data indicating the picture-print.

6. A content evaluation device comprising:
a processor; and
a memory storing a program that, when executed by the processor, causes the content evaluation device to:
calculate a time series of a state feature relating to a drawing state of content created through a series of operations;
obtain an amount of change in the state feature between before and after a single operation or consecutive operations by using the time series of the state feature; and
calculate an operation feature relating to the single operation or consecutive operations from the amount of change.

7. The content evaluation device according to claim 6, wherein
the state feature is a coordinate value on a feature space defined by a concept graph indicating a relation between words.

8. The content evaluation device according to claim 7, wherein
the concept graph is made for each of a plurality of kinds of languages, and
the program, when executed by the processor, causes the content evaluation device to identify a kind of language from at least one of content data indicating the content or related data relating to creation of the content, and calculate the time series of the state feature by using the concept graph corresponding to the kind of language.

9. The content evaluation device according to claim 6, wherein
the program, when executed by the processor, causes the content evaluation device to calculate the time series of the state feature based on at least both raster data and stroke data of the content.

10. The content evaluation device according to claim 6, wherein
the single operation is a stroke operation for drawing one stroke.

11. The content evaluation device according to claim 10, wherein
the operation feature is a magnitude or a direction of a vector that has a first drawing state immediately before execution of the stroke operation as an initial point and has a second drawing state immediately after the execution of the stroke operation as a terminal point.

12. The content evaluation device according to claim 6, wherein the program, when executed by the processor, causes the content evaluation device to:
identify a kind of creation step corresponding to the drawing state of the content by using the time series of the state feature or the operation feature.

13. A content evaluation system comprising:
a user device that, in operation, generates content data indicating content created through a series of operations; and
a server device that, in operation, communicates with the user device, wherein
the server device includes:
at least one processor; and
at least one memory storing a program that, when executed by the at least one processor, causes the server device to:
calculate a time series of a state feature relating to a drawing state of the content, and
obtain an amount of change in the state feature between before and after a single operation or consecutive operations by using the time series of the state feature; and
calculating an operation feature relating to the single operation or consecutive operations from the amount of change.
